(19) United States
(12) Patent Application Publication
(10) Pub. No.: US 2015/0101040 A1
(43) Pub. Date: Apr. 9, 2015

(54) ELECTRONIC APPARATUS, COMPUTER READABLE MEDIUM AND METHOD FOR RELEASING SECURITY

(71) Applicant: Kabushiki Kaisha Toshiba, Tokyo (JP)

(72) Inventor: Daisuke HAYASHI, Ome Tokyo (JP)

(21) Appl. No.: 14/493,697

(22) Filed: Sep. 23, 2014

Related U.S. Application Data
(60) Provisional application No. 61/887,064, filed on Oct. 4, 2013.

(51) Int. Cl. G06F 21/31; G06F 3/041; G06F 3/0488

(52) U.S. Cl. CPC G06F 21/31; G06F 3/04886; G06F 3/0412; G06F 3/0416
USPC 726/19

(57) ABSTRACT

An electronic apparatus includes a display, a touch panel, a controller, an input module, a generator and a display controller. The controller deactivates security of the electronic apparatus when a password is inputted. The input module makes a user input the password by one character. The generator generates a key group including a first character in the password and a character other than the first character. The display controller displays a software key for displaying a character group in the key group as an input target on the display on a password input screen for inputting the password.

### FIELD

The present invention relates to an electronic apparatus, a computer readable medium and a method for releasing security.

### BACKGROUND

At present, an electronic apparatus capable of inputting characters etc. by a touch panel has been widely distributed.

In an electronic apparatus such as a PC or a tablet equipped with a touch panel display, a security function is important and generally, a user often deactivates security by inputting a password. A problem in the case of deactivating security by inputting a password is that a registered user may forget the password. However, in the case of displaying an SW (Software) keyboard by the touch panel display, a display method of the SW keyboard enables password input support of the user even when the registered user forgets the password.

An object of the invention is to provide an electronic apparatus, a program and a security deactivating method in which a user can suitably input a password.

### BRIEF DESCRIPTION OF THE DRAWINGS

FIG. 1 is a perspective view showing one example of an external appearance of an electronic apparatus in an embodiment.

FIG. 2 is a block diagram showing one example of a system configuration of the electronic apparatus in the embodiment.

FIG. 3 is a block diagram showing one example of a configuration of a security function at a BIOS level of the electronic apparatus in the embodiment.

FIG. 4 is a conceptual diagram showing one example of a password input screen displayed on an LCD in normal display in the embodiment.

FIG. 5 is a conceptual diagram showing one example of key groups for performing group display in the embodiment.

FIGS. 6A and 6B are conceptual diagrams showing one example of the password input screen displayed on the LCD in the group display in the embodiment.

FIG. 7 is a conceptual diagram showing one example of the password input screen displayed on the LCD in the group display in the embodiment.

FIG. 8 is a flow diagram showing one example of a flow of security processing in the embodiment.

### DETAILED DESCRIPTION

According to one embodiment, an electronic apparatus includes a display, a touch panel, a controller, an input module, a generator and a display controller. The controller deactivates security of the electronic apparatus when a password is inputted. The input module makes a user input the password by one character. The generator generates a key group including a first character in the password and a character other than the first character. The display controller displays a software key for displaying a character group in the key group as an input target on the display on a password input screen for inputting the password.

Various embodiments will be described hereinafter with reference to the accompanying drawings.

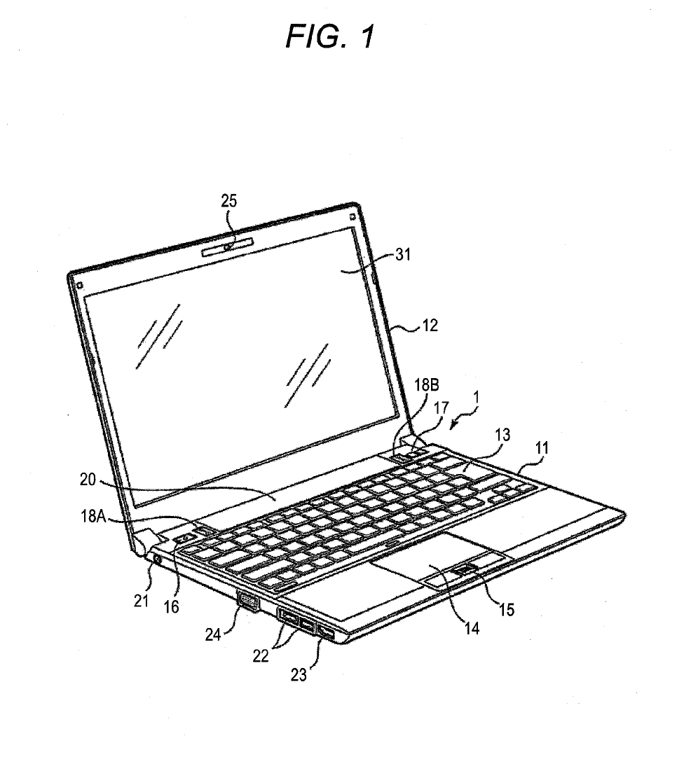

First, a configuration of an electronic apparatus according to the present embodiment will be described with reference to FIG. 1. As shown in FIG. 1, this electronic apparatus can be implemented as, for example, a notebook personal computer 1. The embodiment illustrates the electronic apparatus with the personal computer 1, but is not limited to this, and can also be implemented in the electronic apparatus such as a tablet apparatus, a mobile telephone (smart phone) or a DTV (Digital Television).

FIG. 1 is a perspective view seeing the computer 1 with a display unit opened from the front side. The present computer 1 is configured to receive electric power from a battery 20. The computer 1 includes a computer body 11 and a display unit 12. A display device such as a touch screen display 31 is incorporated into the display unit 12. Further, a camera (Web camera) 25 is arranged in the upper end of the display unit 12.

The display unit 12 is attached to the computer body 11 turnably between an opened position in which an upper surface of the computer body 11 is exposed and a closed position in which the upper surface of the computer body 11 is covered with the display unit 12. The computer body 11 has a cabinet with a thin box shape, and a keyboard 13, a touch pad 14, a fingerprint sensor 15, a power source switch 16 for powering on and off the computer 1, several function buttons 17 and speakers 18A, 18B are arranged on an upper surface of the cabinet.

Also, the computer body 11 is provided with a power source connector 21. The power source connector 21 is formed on a side surface, for example, a left side surface of the computer body 11. An external power source device is detachably connected to this power source connector 21. As the external power source device, an AC adapter can be used. The AC adapter is a power source device for converting a commercial power source (AC electric power) into DC electric power.

The battery 20 is detachably attached to, for example, the back end of the computer body 11. The battery 20 may be a battery built into the computer 1.

The computer 1 is driven by electric power from the external power source device or electric power from the battery 20. When the external power source device is connected to the power source connector 21 of the computer 1, the computer 1 is driven by the electric power from the external power source device. Also, the electric power from the external power source device is used for charging the battery 20. During a period during which the external power source device is not connected to the power source connector 21 of the computer 1, the computer 1 is driven by the electric power from the battery 20.

Further, the computer body 11 is provided with several USB ports 22, an HDMI (High-definition multimedia interface) terminal 23, a VGA (RGB) port 24 and a LAN connector (not shown).

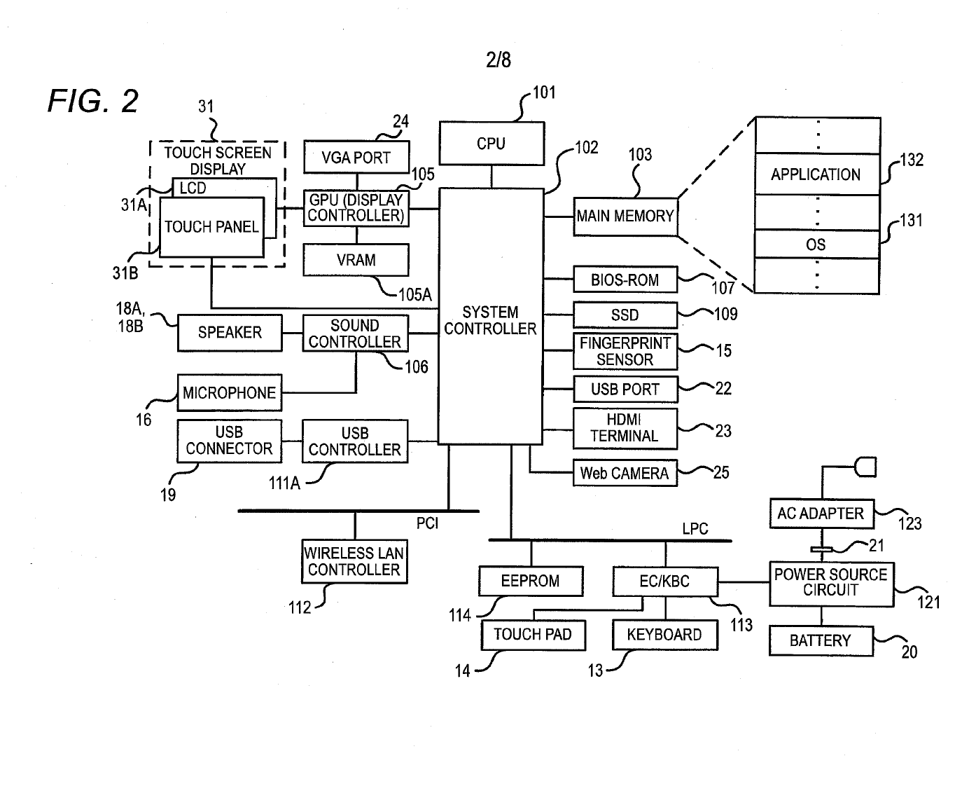

Next, an outline of a system configuration of the electronic apparatus in the embodiment will be described with reference to FIG. 2.

FIG. 2 is a block diagram showing one example of the system configuration of the electronic apparatus in the embodiment.

The computer 1 includes a central processing unit (CPU) 101, a system controller 102, a main memory 103, a graphics controller (GPU) 105, a sound controller 106, a BIOS-ROM 107, a solid-state drive (SSD) 109, a wireless LAN controller 112, an EC/KBC 113, an EEPROM 114, a USB connector 19, the display unit 12, a video memory (VRAM) 105A, etc.

The CPU 101 is a processor for controlling operation of each part in the computer 1. The CPU 101 executes various application programs and an operating system (OS) 131 loaded from the SSD 109 to the main memory 103. The application programs include an application program 132 etc.

The CPU 101 also executes a BIOS (basic input/output system) stored in the BIOS-ROM 107. The BIOS is a program for hardware control.

Also, the BIOS of the computer 1 has a security function. As the security function of the BIOS, the BIOS once suspends processing during start processing of the computer 1 and requests an input of a password from a user. A password specified by a user is recorded on the BIOS-ROM 107 and when the password inputted by the user matches with a password stored in the BIOS-ROM 107, the BIOS deactivates security and resumes the start processing and starts the computer 1. The computer 1 in the embodiment enables an input by an SW (Software) keyboard displayed on the touch screen display 31 in a security password input by the BIOS. The BIOS displays the SW keyboard on the touch screen display 31, and starts the computer 1 when a user inputs a correct password. This security function will be described below in detail.

The system controller 102 is a bridge device for making connection between a local bus of the CPU 101 and each device on a PCI (Peripheral Component Interconnect) bus and each device on an LPC (Low Pin Count) bus. Also, an IDE (Integrated Drive Electronics) controller for controlling the SSD 109 is built into the system controller 102. Further, the system controller 102 has a function of communicating with the sound controller 106. Further, the system controller 102 has a function of communicating with the GPU 105 through a serial bus etc. with PCI EXPRESS standards.

The GPU 105 is a display controller for controlling an LCD 31A used as a display monitor of the computer 1. A video signal (also called a display signal) generated by this GPU 105 is sent to the LCD 31A.

The sound controller 106 is a sound source device, and outputs audio data targeted for generation to the speakers 18A, 18B. The wireless LAN controller 112 is a wireless communication device for conducting wireless communication with, for example, IEEE 802.11 standards.

The EC/KBC 113 is an embedded/keyboard controller for electric power management and control of an input signal from an input device. The EC/KBC 113 has a function of powering on and off the computer 1 according to a manipulation of a user, and a function of accepting manipulation inputs from various input devices. A power source circuit 121 generates operating electric power to supplied to each component of the computer 1 using electric power supplied from the battery 20 in the computer 1 or electric power supplied from an external power source such as an AC adapter 123. Also, the power source circuit 121 charges the battery 20 using electric power supplied from the external power source.

A touch panel 31B as well as the LCD 31A is incorporated into the touch screen display 31. The touch panel 31B stacked and arranged on the LCD 31A has a sensor, an MCU (Micro controller unit), etc. When a touch manipulation is performed on the touch panel 31B, its touched position is detected by the sensor and input information including the touched position (coordinates) on the touch panel 31B is outputted by the MCU.

The video memory (VRAM) 105A is connected to the graphics controller 105. The video memory (VRAM) 105A stores, for example, screen image data corresponding to a screen image displayed on the LCD 31A or an external display.

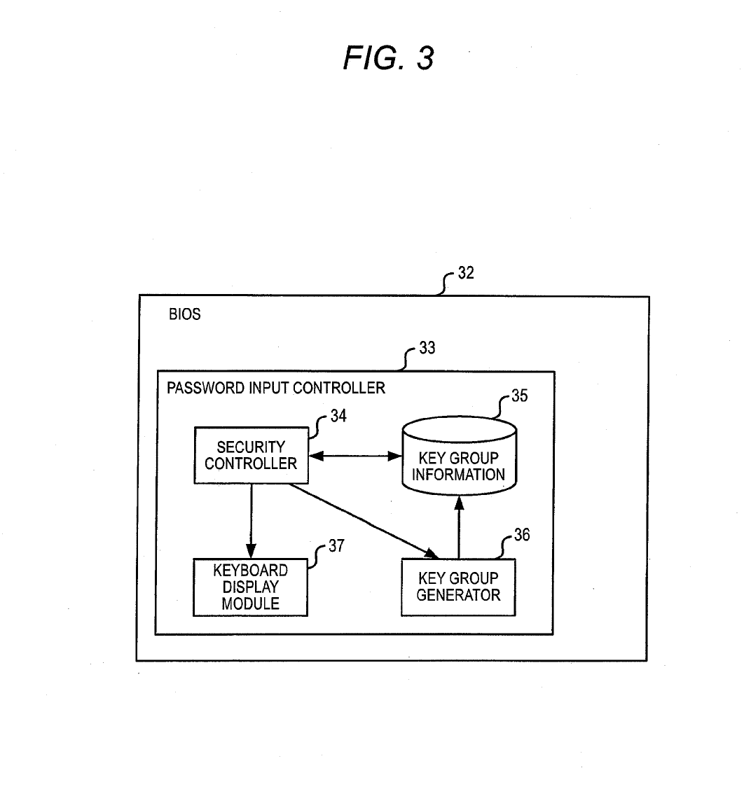

Next, a security function at a BIOS level of the computer 1 in the embodiment will be described using FIG. 3.

FIG. 3 is a block diagram showing one example of a configuration of the security function at the BIOS level of the electronic apparatus in the embodiment.

A BIOS 32 is a program stored in the BIOS-ROM 107 and executed by the CPU 101, and has the security function by a password input from a user as described above.

A password input controller 33 is a module in charge of the security function by a password input of the BIOS 32, and has a security controller 34, key group information 35, a key group generator 36 and a keyboard display module 37.

The security controller 34 has a function of controlling the whole security function by the password input. In this security function, a user can set a security level (strength of security), and the security controller 34 executes processing according to the set security level.

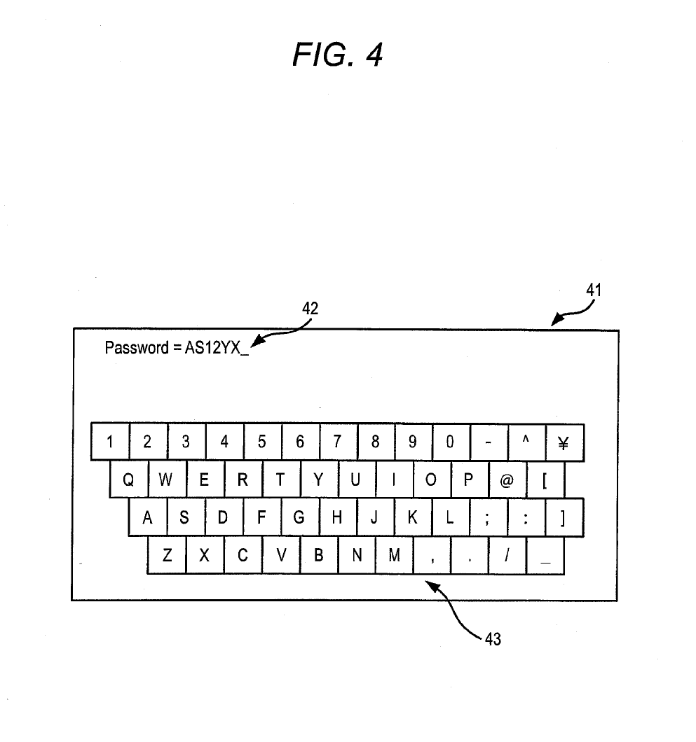

In the security function by the BIOS 32, the computer 1 in the embodiment displays a password input screen on the LCD 31A and makes a user input a password. In this case, the password may be inputted by the keyboard 13, or the SW keyboard may be displayed on the LCD 31A to accept an input by a key touch of this SW keyboard. In a display form of this SW keyboard, the embodiment has two kinds of display forms of normal display and group display. The SW keyboard (SW key) in the normal display is displayed as shown in FIG. 4. The details of these display forms will be described below in subsequent description of FIG. 4.

The key group information 35 is group information about a key in the group display of the SW keyboard (SW key) described above. The key group information 35 is stored in the BIOS-ROM 107. The key groups are generated by the number of characters of a password, and each of the groups is constructed of a character group respectively including one character in the password. For example, when the password is a password of six characters of “AS12YX”, the key groups corresponding to the six characters are generated, for example, “key group 1” including “A” of the leading character, “key group 2” including “S” of the next character and so on are generated.

The key group generator 36 has a function of generating the key groups described above. In the key groups, automatic setting by the key group generator 36 and arbitrary setting by a user can be made. The character group in the key group includes a character included in the password and characters other than its character and normally, the key group generator 36 automatically sets the characters which are not included in the password (automatic setting). The characters which are not included in this password may be arbitrarily set by the user (arbitrary setting by the user).

The keyboard display module 37 has a function of displaying SW keyboards of normal display and group display on the LCD 31A.

Next, normal display and group display will be described.

FIG. 4 is a conceptual diagram showing one example of a password input screen 41 displayed on the LCD 31A in the normal display.

In the normal display, the password input screen 41 is displayed on the LCD 31A. A password input area 42 and an SW keyboard 43 of the normal display are displayed on the password input screen 41.

In the SW keyboard 43, respective characters are arranged in arrangement corresponding to key arrangement of a general HW keyboard, and a user can input a password in the password input area 42 by touching this SW keyboard 43.

Here, key groups of the group display will be described.

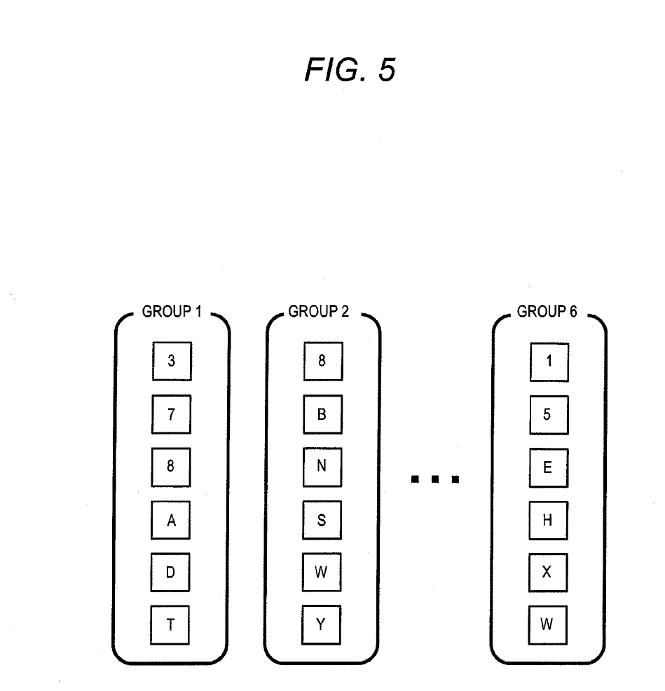

FIG. 5 is a conceptual diagram showing one example of key groups for performing the group display in the embodiment.

Also herein, the case where a password has six characters of “AS 12YX” will be described by way of example. FIG. 5 shows plural key groups in the password “AS12YX”. The groups have six groups of 1 to 6, and the Nth character of the password “AS12YX” is included in a character group of a group N. For example, characters of “3”, “7”, “8”, “A”, “D” and “T” are included in a “group 1”, and “A” of these characters is the leading (first) character of the password “AS12YX”.

In the group display of the case of inputting the password, the SW keyboard (also called the SW key) is displayed every group. Also, a display position on the SW keyboard of the character group inside this group is displayed in a random position rather than a position corresponding to the HW keyboard.

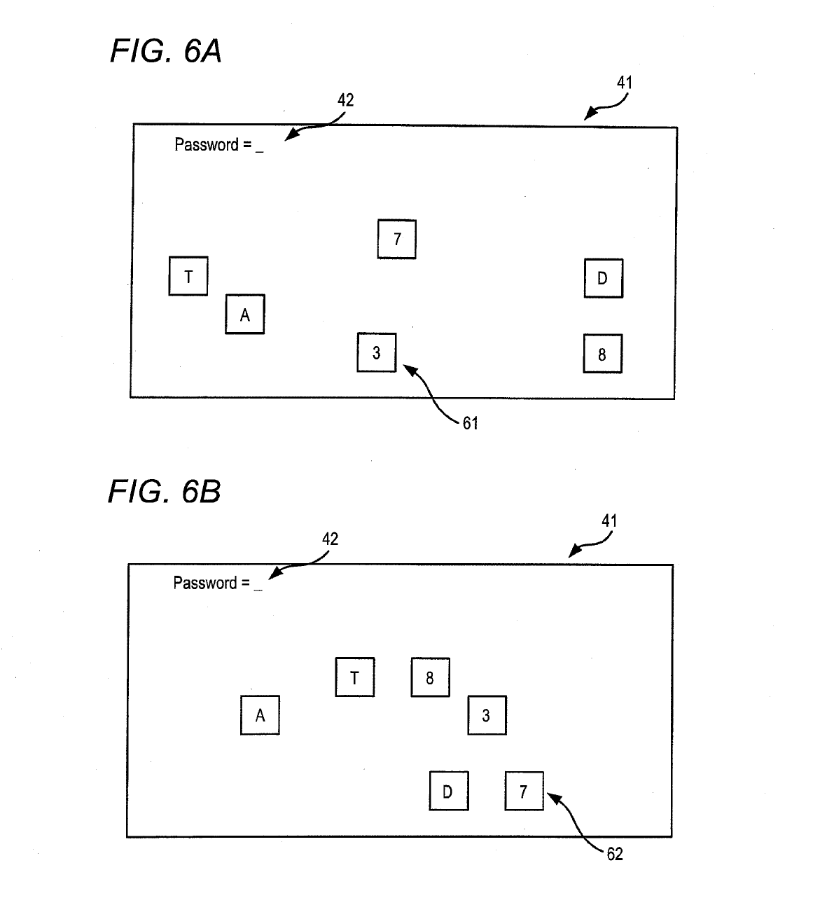

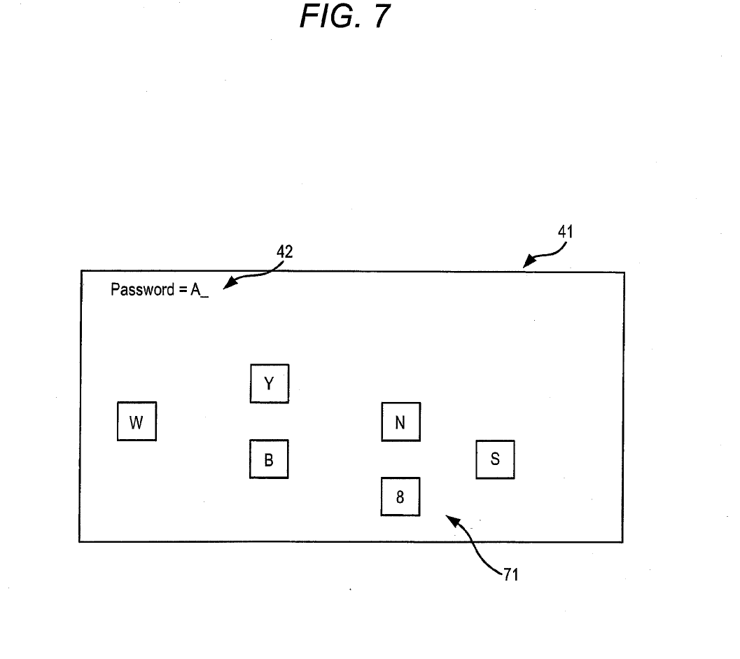

Next, display examples in the group display are shown in FIGS. 6 and 7.

FIGS. 6 and 7 are conceptual diagrams showing one example of the password input screen 41 displayed on the LCD 31A in the group display. FIGS. 6A and 6B are the password input screens 41 for inputting the first character of the password, and FIG. 7 is the password input screen 41 for inputting the second character of the password.

In the case of performing the group display, the computer 1 changes arrangement of each character of the SW keyboard every timing of the start of the BIOS. FIGS. 6A and 6B are the password input screens 41 for inputting the first character of the same password, but are the screens at the time of the different starts, and arrangement of the character group of the SW keyboard differs.

When “AS12YX” is the password, an SW keyboard 61 or an SW keyboard 62 for inputting the first character is first displayed on the password input screen 41 as shown in FIGS. 6A and 6B. In order to input the first character of the password, a character group of a “group 1” including “A” which is the first character is displayed in a random position in the SW keyboard 61, 62. Characters other than “A” in the “group 1” are also displayed in the SW keyboard 61, 62. The SW keyboards shown in FIGS. 6A and 6B differ in key arrangement, but the displayed keys other than “A” are the characters included in the “group 1”, and characters other than the characters defined by the “group 1” are not included in the SW keyboard 61, 62.

A user can select the first character “A” of the password from among the SW keyboard 61, 62 and input the first character.

When the user inputs the first character “A” of the correct password, the SW keyboard in the password input screen 41 is switched and the password input screen 41 shown in FIG. 7 is displayed. In FIG. 7, a character group in a “group 2” which is a group including the second character of the password is displayed in random arrangement. When the password is correctly selected and inputted in this manner, a character group of the next group is displayed in random arrangement, and this display and switching of the display are continued until the last character of the password.

Since the character group in the group is displayed in random arrangement and is further arranged in a different position every start in the embodiment, it becomes difficult to guess the inputted password by fingerprints of the user left on the touch panel 31B.

Next, a flow of the processing will be described.

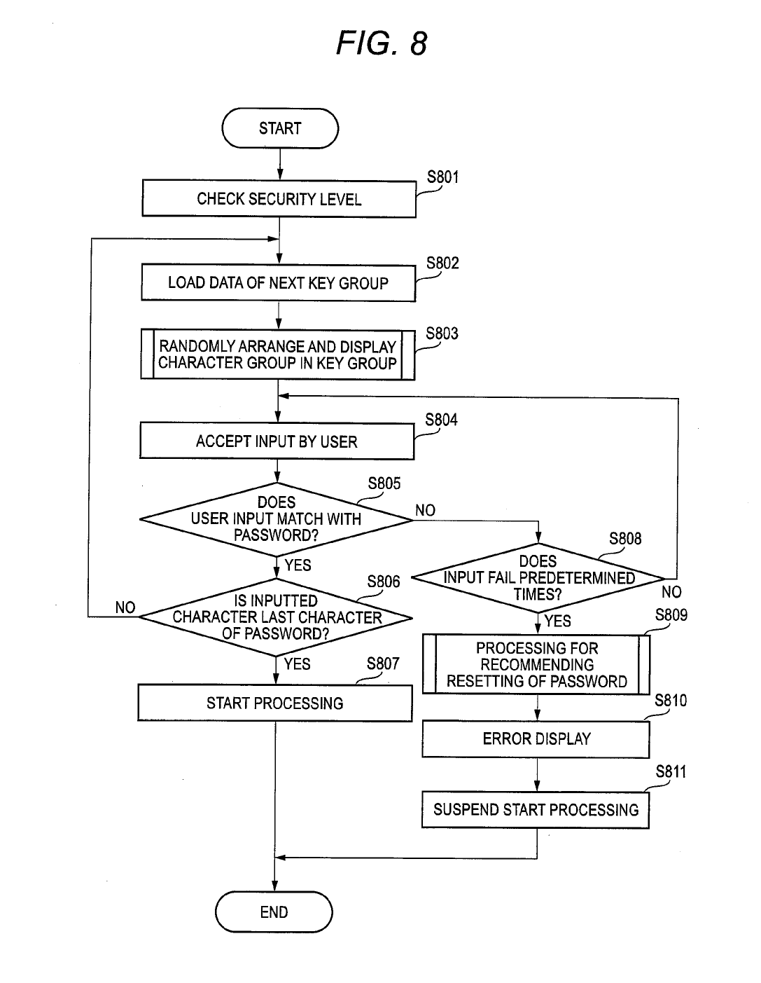

FIG. 8 is a flow diagram showing one example of a flow of security processing in the embodiment.

First, the security controller 34 checks a security level set in a security function (step S801). The security level indicates the strength of security in the present security function, and the strength of security is higher when the security level is higher. When the security level is high, more characters are displayed inside the character group in the group of the password as compared with the case where the security level is low. When the security level is low, only a part of the characters in the character group in the group of the password are displayed. Since the higher security level has more candidates for one character of the inputted password, it becomes difficult for an unauthorized user to guess the password, and since the lower security level has less candidates for one character of the inputted password, an authorized user can easily recall the password. The user can set the security level, and the set security level is reflected at the time of the next start.

After the completion of step S801, the security controller 34 loads information about a key group of the next character of the password from the key group information 35 (step S802). When an input target is the leading character of the password, the loaded key group becomes a key group of the leading character.

Next, the security controller 34 randomly arranges a character group in the key group, and displays the character group on the keyboard display module 37 (step S803).

When the keyboard display module 37 displays the character group in the key group as an SW keyboard, the security controller 34 accepts an input of the password from a user using this SW keyboard (step S804). When a character inputted from the user matches with the registered password (step S805: Yes), the security controller 34 then determines whether or not the inputted character is the last character of the password (step S806).

When the inputted character is not the last character in step S806 (step S806: No), the processing flow returns to step S802.

When the inputted character is the last character in step S806 (step S806: Yes), the BIOS 32 executes (resumes) the start processing (step S807).

When the input of the user does not match with the password in step S805 (step S805: No), this is counted as failure, and the security controller 34 determines whether or not the input of the password fails predetermined times (step S808).

When the number of failures does not reach the predetermined times in step S808 (step S808: No), the processing flow returns to step S804.

When the number of failures reaches the predetermined times in step S808 (step S808: Yes), the security controller 34 executes processing for recommending the user to reset the password (step S809). When the user correctly inputs the password next time to succeed in the start by executing the present processing, notification that “resetting of the password is recommended since an unauthorized user may have access last time” can be provided. Also, the processing executed in step S809 illustrates the processing for recommending the user to reset the password in the embodiment, but is not limited to this processing and, for example, processing for recommending that a security level should be increased may be executed. When the user correctly inputs the password next time to succeed in the start by executing this processing, notification that “an increase in the security level is recommended since an unauthorized user may have access last time” can be provided.

After the completion of processing of step S809, the security controller 34 performs display for notifying the user of an error due to the predetermined number of failures in the password input on the LCD 31A (step S810), and the BIOS 32 suspends the start processing (step S811).

After the completion of processing of step S807 or step S811, all the processing flows of the security function in the embodiment are ended.

The embodiment illustrates the case where the security function about the password input is included in the function of the BIOS, but is not limited to this case, and the function may be a function of an OS or utility software.

In the embodiment, a user can easily recall a password since candidates for a character of the password are displayed one by one when the user forgets the password.

Further, in the embodiment, a group including characters different from each character of the password is constructed and is displayed as input candidates. At the time of the different starts, key arrangement positions in which the respective characters are displayed are changed, but the characters in the group are displayed every time as a character group displayed as keys. For example, when the group is not constructed and characters different from a character included in the password are randomly selected and displayed at the time of each start, the characters other than the character of the password differ every start and the character displayed every time is remembered and thereby, it becomes easy for an unauthorized user to guess the password. In order to avoid such a disadvantage in the embodiment, the group displayed for each character of the password is constructed and the same character group is displayed every time as the SW keyboard and thereby, it becomes difficult for the unauthorized user to guess the password and security is improved. That is, an authorized user can easily recall the forgotten password and moreover, it becomes difficult for the unauthorized user to guess the password and thereby, high security can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display;
a touch panel;
a controller configured to deactivate security of the electronic apparatus based on a password;
an input controller configured to prompt input of a character;
a generator configured to generate a key group including a first character in the password and a second character other than the first character; and
a display controller configured to display a software key for displaying a character group in the key group as an input target.

2. The electronic apparatus of claim 1,
wherein the generator generates the key groups for all the characters in the password.

3. The electronic apparatus of claim 1,
wherein the display controller changes a display position of the software key every time a password input screen is displayed.

4. The electronic apparatus of claim 1, further comprising:
a notifying module configured to recommend a user to change the password when the user fails to input the password predetermined times.

5. The electronic apparatus of claim 1,
wherein the controller is a basic input and output system (BIOS).

6. The electronic apparatus of claim 1,
wherein the controller executes start processing when the security is deactivated.

7. A non-transitory computer readable medium storing a program that causes an electronic apparatus to execute a processing, the electronic apparatus comprising a display, a touch panel, a controller, an input controller, a generator and a display controller, the processing comprising:
causing the controller to deactivate security based on a password;
causing the input controller to prompt input of a character;
causing the generator to generate a key group including a first character in the password and a second character other than the first character; and
causing the display controller to display a software key for displaying a character group in the key group as an input target.

8. A security releasing method comprising:
generating by an electronic apparatus a key group including a first character in a password and a second character other than the first character;
displaying a software key for displaying a character group in the key group as an input target on a password input screen for inputting the password;
prompting input of a character on the password input screen; and
deactivating security when the password is inputted.
